(19) United States
(12) Patent Application Publication
(10) Pub. No.: US 2026/0168546 A1
(43) Pub. Date: Jun. 18, 2026

(54) ELECTROMAGNETIC BRAKE OR CLUTCH

(71) Applicant: KENDRION (VILLINGEN) GMBH, Villingen-Schwenningen (DE)

(72) Inventors: Salvatore QUARTARONE, Tuningen (DE); Pascal FRIESE, Villingen-Schwenningen (DE); Marc SCHRENK, Geislingen (DE); Frank MÜLLER, St. Georgen (DE); Fabian HOER, Brigachtal (DE)

(21) Appl. No.: 19/424,056

(22) Filed: Dec. 17, 2025

(30) Foreign Application Priority Data
Dec. 18, 2024 (DE) 10 2024 138 777.7

(51) Int. Cl. F16D 59/02; F16D 27/04; F16D 121/22

(52) U.S. Cl. CPC F16D 59/02; F16D 27/04; F16D 2121/22

(57) ABSTRACT

The present invention relates to an electromagnetic brake (1) or clutch, comprising an electromagnet (10) arranged annularly around a longitudinal axis (L) with a magnet housing (20) having an inner pole (14) and an outer pole (16), an armature disk (40), and a hub flange (50), wherein the armature disk (40) is arranged between the hub flange and the electromagnet so as to be movable along the longitudinal axis (L) and can interact with the inner pole (14) and/or the outer pole (16) in a frictionally engaged manner, wherein at least one first elastic damping element (60) is provided between the electromagnet (10) and the armature disk (40) and/or at least one second elastic damping element (70) is provided between the armature disk (40) and the hub flange (50) for braking a movement of the armature disk (40).

The present invention relates to an electromagnetic brake or clutch with the features of claim 1.

Electromagnetic brakes or clutches are known from the state of the art in various designs. In the state of the art, generic electromagnetic brakes are used, for example, as permanent magnet brakes or spring-applied brakes and comprise an electromagnet that can interact with an armature disk in order to actuate a tribological system of the brake or clutch or bring it into frictional contact.

Typically, the electromagnet comprises a pot-shaped and ring-shaped magnet housing with an inner pole and an outer pole, which can be arranged around a longitudinal axis and a shaft, e.g. the shaft of a servomotor or a rotary joint. The inner pole and the outer pole are arranged on the armature side of the magnet housing, with an air gap typically being arranged between the inner pole and the outer pole.

The magnet housing has an inner ring section, a base section and an outer ring section, with the inner ring section, the base section and the outer ring section surrounding an annular space in which the excitation coil is arranged. The base section is arranged on the side facing away from the armature disk and on the armature side the magnet housing can have a flange section that forms the air gap and the inner pole or the outer pole.

The inner pole and/or the outer pole can form friction surfaces, which is why generic electromagnetic brakes or clutches are also referred to as pole friction brakes or clutches.

To actuate the electromagnetic brake or clutch, the electromagnet is energized and the armature disk moves along the longitudinal axis to come into frictional contact with a friction partner, e.g. the inner pole and/or the outer pole. When the armature disk strikes, the armature disk is abruptly decelerated and a shock is generated, which is perceived as disruptive in some electromagnetic brake or clutch applications.

In the state of the art, permanent magnets are widely used as resetting means. When the electromagnet is de-energized, the brake is actuated by the permanent magnet, for example, to achieve an emergency stop in the event of a power failure.

This is where the present invention comes in.

The present invention is therefore based on the object of proposing a suitably improved electromagnetic brake or clutch which eliminates the disadvantages known from the prior art.

These objects are achieved by an electromagnetic brake or clutch with the features of claim 1.

Further developments of the invention are specified in the dependent claims.

The electromagnetic brake or clutch according to the invention with the features of claim 1 comprises a ring-shaped electromagnet. The electromagnet is formed around a longitudinal axis and has an inner pole and an outer pole.

The electromagnetic brake or clutch also has an armature disk and a hub flange. The armature disk is arranged between the hub flange and the electromagnet so that it can move along the longitudinal axis and can interact with the inner pole and/or the outer pole of the electromagnet in a frictionally engaged manner.

The armature disk can preferably be moved between a first position and a second position or vice versa by the electromagnet, with the brake or clutch being preferably open in the first position and closed in the second position.

According to the invention, at least one first elastic damping element is provided between the electromagnet and the armature disk and/or at least one second elastic damping element is provided between the armature disk and the hub flange for braking or decelerating a movement of the armature disk.

The present invention is based on the idea of proposing an electromagnetic brake or an electromagnetic clutch in which the armature disk is decelerated by the at least one first damping element and/or by the at least one second damping element during movement along the longitudinal axis shortly before striking the electromagnet or the inner pole and/or the outer pole or the hub flange, thereby reducing shifting noises.

Due to the fact that the at least one first damping element and/or the at least one second damping element only decelerates the armature disk shortly before it strikes the electromagnet or the inner pole and/or the outer pole or the hub flange, the shifting behavior remains substantially unchanged compared to an electromagnetic brake or an electromagnetic clutch without these damping elements.

According to a further development of the invention, the at least one first damping element and/or the at least one second damping element is elastically deformed by a displacement A when the armature disk is braked or decelerated, the displacement preferably being 0.02 mm≤A≤0.5 mm. The displacement is preferably an elastic compression.

According to a further development, the at least one first damping element and/or the at least one second damping element is dimensioned in such a way that the static and/or dynamic friction between the inner pole and/or the outer pole and the armature disk resulting from the frictional connection is reduced by less than 50%, preferably by less than 40% and more preferably by less than 30%.

A further development of the present invention provides that the at least one first elastic damping element is arranged in such a way that the armature disk is decelerated by an elastic deformation of the at least one first elastic damping element before the armature disk can interact with the inner pole and/or the outer pole in a frictionally engaged manner.

Furthermore, it has proven to be advantageous if the inner pole and/or the outer pole are/is formed by a projection projecting from the housing. The inner pole and/or the outer pole form friction surfaces that interact with the armature disk. The friction surfaces can often have a different surface quality than the other surfaces of the magnet housing. By forming the inner pole and/or the outer pole with a projection projecting from the housing, the friction surfaces can be easily reworked.

A further development of the present invention provides that the housing comprises a flange section, and that the inner pole is arranged on the armature side of the flange section.

It has also proven to be advantageous if the electromagnetic brake or clutch is a permanent magnet brake or clutch and has a permanent magnet. The permanent magnet is arranged on or in the magnet housing. The armature disk can be held permanently magnetic at the inner pole and/or the outer pole by the magnetic field of the permanent magnet.

The magnet housing may have an inner ring section, a base section and/or an outer ring section, with the inner ring section, the base section and the outer ring section surrounding an annular space in which the excitation coil is arranged. The base section is arranged on the side facing away from the armature disk and connects the inner ring section to the outer ring section. On the armature side, the magnet housing can have the flange section, which forms a gap or air gap and the inner pole or the outer pole. Typically, the air gap is formed between the flange section and the outer ring section and the flange section has the inner pole.

The permanent magnet is preferably arranged in the gap. The permanent magnet is also preferably radially magnetized, whereby on the one hand a strong permanent magnetic holding force can be generated and on the other hand the magnetic field of the permanent magnet can be displaced, diverted and neutralized by a generated counter field when the electromagnet is energized, allowing the brake to open.

According to a preferred further development of the present invention, the at least one first elastic damping element is arranged on the magnet housing.

A further development of the present invention provides that the at least one first elastic damping element is arranged on the armature side of the magnet housing adjacent to the inner pole and/or to the outer pole. Preferably, the at least one first elastic damping element is arranged radially within the inner pole and/or the outer pole in relation to the longitudinal axis.

The at least one first elastic damping element can also be arranged on the side of the armature disk facing the magnet housing.

In a further embodiment, the at least one first elastic damping element can protrude beyond the inner pole and/or the outer pole. In other words, the at least one first elastic damping element protrudes from the magnet housing, with the inner pole and/or the outer pole being arranged offset in the longitudinal axis relative to the at least one first elastic damping element. A distance, measured in the longitudinal axis between the at least one first elastic damping element and the inner pole and/or the outer pole, preferably corresponds to the elastic displacement or compression which the at least one first elastic damping element undergoes during deceleration or braking of the armature disk.

Furthermore, it has proven to be advantageous if the at least one second elastic damping element is arranged in such a way that the armature disk comes into contact with the hub flange in a damped manner as a result of elastic deformation or compression of the at least one second elastic damping element. The at least one second damping element brakes or decelerates the armature disk only shortly before it strikes the hub flange, which significantly reduces the shifting noise. On the other hand, the switching behavior—or more precisely the opening behavior—remains substantially unchanged compared to an electromagnetic brake or an electromagnetic clutch without these second damping elements.

A preferred further development of the present invention provides that the at least one second elastic damping element is arranged on the hub flange and/or the armature plate.

The at least one second elastic damping element preferably protrudes from the hub flange on the side facing the armature disk in the direction of the armature disk or from the armature disk on the side of the armature disk facing the hub flange in the direction of the hub flange.

Furthermore, it has proven to be advantageous if the electromagnetic brake or the electromagnetic clutch has at least one adjusting means. The at least one adjusting means is configured to adjust a distance between the armature disk and the inner pole and/or the outer pole.

The at least one adjusting means can, for example, comprise a spacer, a grub screw, a pin, a bolt or a screw. The distance between the hub flange and the armature disk and thus—preferably indirectly—a distance between the armature disk and the inner pole and/or the outer pole can be adjusted, for example—preferably directly—by the at least one adjusting means.

According to a preferred further development, the at least one adjusting means can have the at least one second elastic damping element. For example, as already mentioned above, the at least one adjusting means can comprise a screw, a grub screw or a pin that projects from the hub flange in the direction of the armature disk. The at least one second damping means can be arranged on the armature disk side on the at least one adjusting means, wherein it should be noted at this point that the at least one adjusting means can be the at least one second damping means.

A further embodiment of the present invention provides that the armature disk comprises the at least one first elastic damping element and/or the at least one second elastic damping element. The at least one first elastic damping element can be arranged on the side of the armature disk facing the magnet housing and/or the at least one second elastic damping element can be arranged on the side of the armature disk facing the hub flange.

The at least one first elastic damping element and/or the at least one second elastic damping element can protrude from the armature disk.

A further embodiment of the present invention provides that the at least one first damping element and the at least one second elastic damping element are a one-piece damping element. In this embodiment, the one-piece damping element is preferably arranged on the armature disk. The one-piece damping element can engage around and/or through the armature disk. For example, it can be advantageous if the one-piece damping element engages through the armature disk in corresponding perforations.

In addition, it has proven to be advantageous if the armature disk is pulled against the hub flange by at least one resetting means. For example, the at least one resetting means can be a leaf spring.

The at least one resetting means can, for example, act against electromagnets and ensure that the armature disk is lifted off the electromagnet when the electromagnet is de-energized and the armature disk is arranged in the first position.

In one embodiment of the electromagnetic brake or clutch with a permanent magnet, the at least one resetting means can lift the armature disk from the electromagnet when the electromagnet is energized and an electromagnetic counter-field of the electromagnet displaces, redirects or neutralizes the magnetic field from the permanent magnet.

A further embodiment of the present invention provides that the at least one first elastic damping element and/or the at least one second elastic damping element is an organic or inorganic friction lining, a nonwoven, e.g. felt wool M-3FAA or a viscoelastic plastic, e.g. a mixed-cell PUR elastomer, which is known under the trade name Sylomer®, for example.

A further development of the present invention provides that the at least one first elastic damping element and/or the at least one second elastic damping element is arranged in a force-, form- and/or material-locking manner. For example, it can be advantageous if the at least one first elastic damping element and/or the at least one second elastic damping element is glued or molded on. As a result, the at least one first elastic damping element and/or the at least one second elastic damping element can be arranged in a simple manner.

Furthermore, it has proven to be advantageous if a plurality of first elastic damping elements and/or a plurality of second elastic damping elements are arranged around the longitudinal axis. For example, the elastic damping elements can be arranged as individual elements, e.g. arc-shaped individual elements, around the longitudinal axis, with the elastic damping elements preferably being arranged rotationally symmetrically around the longitudinal axis.

According to a further provision of the present invention, the at least one first elastic damping element and/or the at least one second elastic damping element are/is arranged or inserted in a recess. This allows the elastic damping element to be arranged in a particularly reliable manner, in particular also secured against displacement.

With reference to the accompanying drawings, four embodiment examples are described in detail below. In the figures:

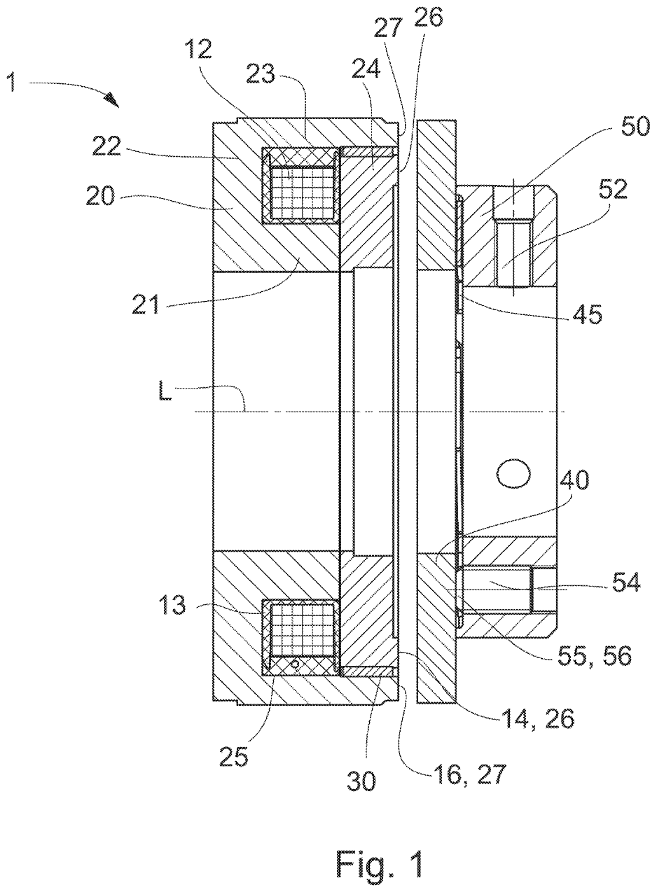

FIG. 1 is a sectional view of an electromagnetic brake with an electromagnet, an armature disk, a permanent magnet and a flange hub according to the state of the art,

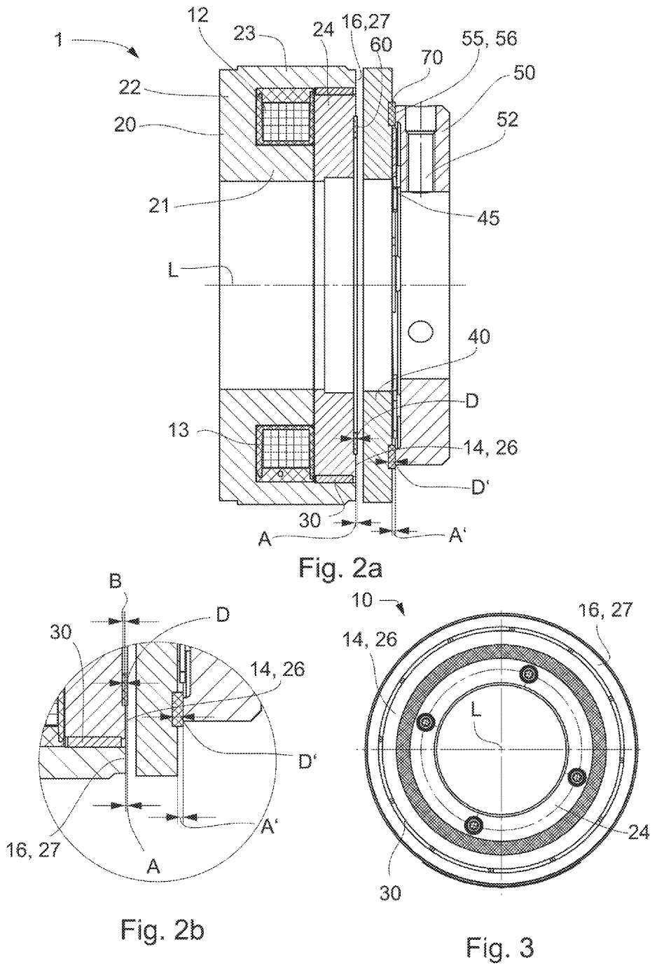

FIG. 2a is a sectional view of an electromagnetic brake according to a first embodiment example,

FIG. 2b is a detailed view according to FIG. 2a,

FIG. 3 is a top view of a side of the electromagnet facing the armature disk according to FIG. 2a,

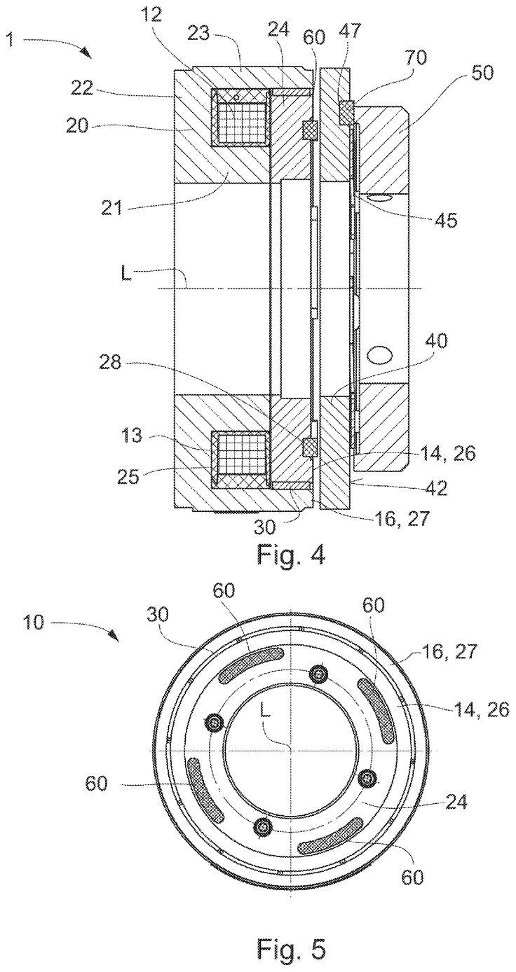

FIG. 4 is a sectional view of an electromagnetic brake according to a second embodiment example,

FIG. 5 is a top view of a side of the electromagnet facing the armature disk according to FIG. 4,

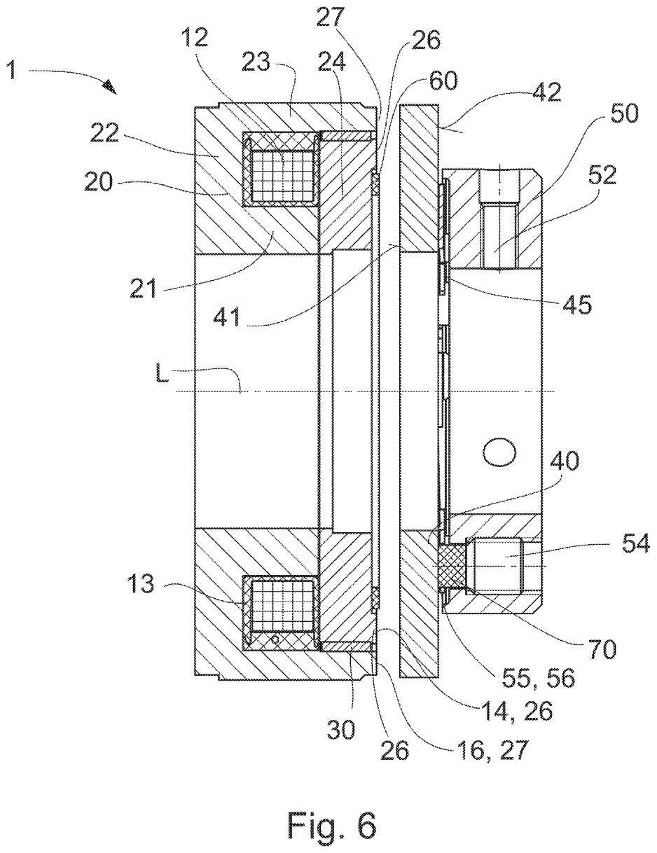

FIG. 6 is a sectional view of an electromagnetic brake according to a third embodiment example,

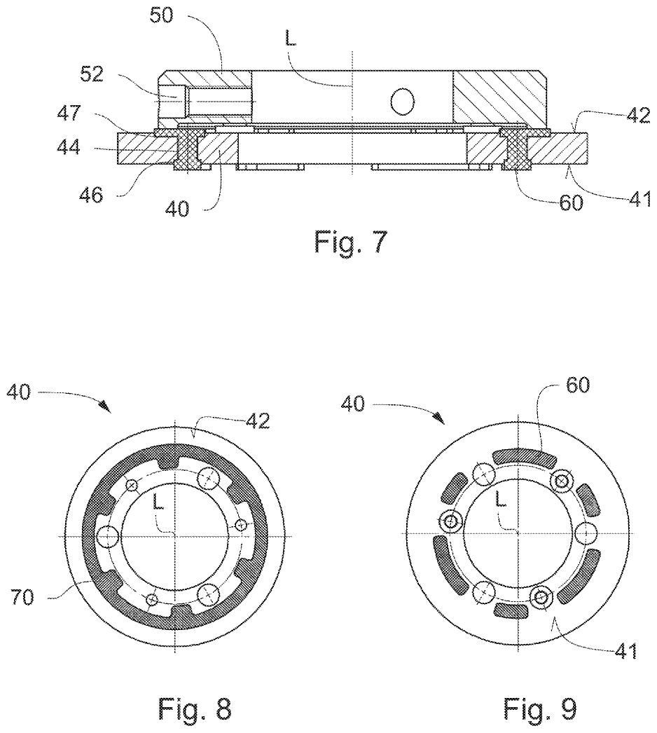

FIG. 7 is a sectional view of the flange hub and the armature disk according to a fourth embodiment example,

FIG. 8 is a top view of a first contact side of the armature disk according to FIG. 7, and

FIG. 9 is a top view of a second contact side of the armature disk according to FIG. 7.

Identical or functionally identical parts or features are identified with the same reference signs in the following detailed description of the figures. Similarly, not all identical or functionally identical parts or features are given a reference number in the figures.

First, the general structure of an electromagnetic brake 1 is described in detail with reference to FIG. 1. The various embodiment example shown in FIGS. 2 to 9 are then described, with only a brief description of the differences.

FIG. 1 shows an exemplary embodiment of an electromagnetic brake 1 with an electromagnet 10, a permanent magnet 30, an armature disk 40 and a hub flange 50. The electromagnetic brake 1 with the permanent magnet 30 can also be referred to as a permanent magnet brake 1.

The electromagnetic brake 1 can also have a permanent magnet 30, which, as will be explained below, can generate a braking force.

The electromagnet 10 comprises a pot-shaped and ring-shaped magnet housing 20 that is arranged rotationally symmetrically along a longitudinal axis L.

The magnet housing 20 is preferably made of a ferromagnetic material and has an inner ring section 21, a base section 22 and an outer ring section 23.

The inner ring section 21, the base section 22 and the outer ring section 23 surround an annular space 25 in a U-shape, in which the excitation coil 12 is arranged.

The excitation coil 12 can be arranged on a coil carrier 13 as shown.

The base section 22 is arranged on the side facing away from the armature disk 40 and connects the inner ring section 21 with the outer ring section 23.

The inner ring section 21, the base section 22 and/or the outer ring section 23 can be connected to one another in one piece or in a known manner.

It can also be seen from FIG. 1 that the magnet housing 20 has a flange section 24 on the side facing the armature disk 40 (i.e. on the armature side).

The flange section 24 can project from the inner ring section 21 to the outer ring section 23, wherein either an air gap (not shown) can be formed between the flange section 24 and the outer ring section 23 or, as shown in FIG. 1, a permanent magnet 30 can be arranged.

The permanent magnet 30 is hollow cylindrical and can be radially magnetized.

On the armature side, the magnet housing 20 has an inner pole 14 and an outer pole 16, the inner pole 14 and/or the outer pole 16 being formed on the armature side on the surfaces facing the armature disk 40, in particular the end faces, which can interact with the armature disk 40 in a frictionally engaged manner.

The inner pole 14 and/or the outer pole 16 can be formed by a projection 26, 27 projecting from the magnet housing 20. The inner pole 14 can be formed by the projection 26 projecting from the magnet housing 20 or from the flange section 24 and/or the outer pole 16 can be formed by the projection 27 projecting from the magnet housing 20 or from the outer ring section 23.

As can also be seen from the accompanying figures, the inner pole 14 and the outer pole 16 can be arranged in a common plane. However, it is noted that it is quite possible to arrange the inner pole 14 and the outer pole 16 in parallel and spaced-apart surfaces.

The armature disk 40 is arranged rotationally symmetrically around the longitudinal axis L and is made of a ferromagnetic material.

The armature disk 40 has a first contact side 41 and a second contact side 42, with the first contact side 41 facing the magnet housing 20 and the contact side 42 facing the hub flange 50.

The hub flange 50 can be non-rotatably connected to a shaft (not shown) by means of fastening means 52.

On the side facing the armature disk 40, the hub flange 50 has a stop 55 which preferably protrudes along the longitudinal axis L and which is preferably designed as a ring-shaped stop surface 56.

Further, the hub flange 50 may have one or more adjusting means 54 configured to adjust a distance between the armature disk 40 and the inner pole 14 and/or the outer pole 16. As shown as an example in FIG. 1, the adjusting means 54 can comprise a grub screw which forms the stop 55.

The armature disk 40 is arranged between the electromagnet 10 and the hub flange 50 and is movable along the longitudinal axis L.

The armature disk 40 is connected to the hub flange 50 by means of resetting means 45, wherein in the illustrated embodiment example the resetting means 45 is formed by leaf springs which pull the armature disk 40 along the longitudinal axis L toward the hub flange 50 against the stop 55.

The resetting means 45 are arranged on the hub flange 50 within the stop surface 56.

The armature disk 40 can be arranged in a first position and in a second position, wherein the first position is shown in the accompanying FIGS. 1, 2, 4, 6 and 7. In the first position, the electromagnetic brake 1 is open and the armature disk 40 rests against the hub flange 50—in particular against the stop 55—with the resetting means 45 holding the armature disk 40 in the first position.

In the second position, the armature disk 40 rests against the magnet housing 20, specifically against the inner pole 14 and/or the outer pole 16.

In the illustrated embodiment example, the armature disk 40 is held permanently magnetically in the second position by the permanent magnet 30, in which the brake 1 is closed.

To open the electromagnetic brake 1, which is designed as a permanent magnet brake, the excitation coil 12 is energized, whereby the permanent magnetic field acting on the armature disk 40 is displaced, redirected and neutralized by an electromagnetic counter-field of the electromagnet 10, whereby the electromagnetic brake 1 can then be opened by the resetting force of the resetting means 45. The armature disk 40 is pulled along the longitudinal axis L to the hub flange 50 and comes into abrupt contact with it—preferably on the stop surface 56.

Once the excitation coil 12 is de-energized, the armature disk 40 is pulled along the longitudinal axis L towards the electromagnet 10 by the permanent magnetic field and abruptly comes into contact with the inner pole 14 and/or the outer pole 16.

When the armature disk 40 strikes the electromagnet 10 or the hub flange 50, the impact generates loud noises that are perceived as disturbing in various applications.

In order to avoid the generation of noise, the electromagnetic brakes 1 or electromagnetic clutches according to the embodiments shown in FIGS. 2-9 comprise at least one first damping element 60 and/or at least one second damping element 70, by means of which the armature disk 40 is decelerated or braked shortly before it strikes the magnet housing 20 and/or the hub flange 50.

At this point, it should be noted that the embodiment examples described below can be combined with one another in any manner.

The first embodiment example is shown in FIGS. 2a, 2b and 3, wherein it can be seen from FIG. 2a that the first damping element 60 is arranged on the armature side of the magnet housing 20. The second damping element 70 is arranged on the side of the armature disk 40 facing the hub flange 50.

As shown, the first damping element 60 can be annular in shape and can be arranged radially within the inner pole 14 in a rotationally symmetrical manner about the longitudinal axis L.

The first damping element 60—measured along the longitudinal axis L—has a thickness D.

As indicated in FIG. 2a, the first damping element 60 is arranged on the magnet housing 20, preferably adjacent to the inner pole 14 and/or the outer pole 16.

The detailed illustration according to FIG. 2b shows that the projection 26 protrudes from an end face facing the armature plate 40 at a distance B.

More precisely, the first damping element 60 is arranged radially within the inner pole 14 and next to the projection 26 and protrudes from the magnet housing 20. The first damping element 60 projects beyond the inner pole 14 and/or the outer pole 16 at a distance A, the distance A being measured parallel to the longitudinal axis L.

The distance A between the at least one first elastic damping element 60 and the inner pole 14 and/or the outer pole 16 preferably corresponds to the elastic displacement or compression which the at least one first elastic damping element 60 undergoes during deceleration or braking of the armature disk 60. The distance A is therefore many times smaller than the thickness D of the first damping element 60, with the following more preferably applying to the distance A: 0.02 mm≤A≤0.5 mm.

The thickness D is also greater than the distance B.

As indicated in FIG. 2a, the at least one second damping element 70 is arranged on the second contact side 42 of the armature disk 40 and projects freely from the armature disk 40, measured along the longitudinal axis, at a distance A′ from the hub flange 50.

The at least one second damping element 70—measured along the longitudinal axis L—has a thickness D′.

The second damping element 70 can be inserted into a recess 47 on the side facing the hub flange 50—i.e. the second contact side 42—with the shape of the recess 47 preferably corresponding to the shape of the second damping element 70. The second damping element 70 protrudes from the recess 47, preferably at a distance A′.

The second damping element 70 can be annular in shape and interacts with the stop surface 56 of the hub flange 50.

The at least one first damping element 60 and/or the at least one second damping element 70 can, for example, be arranged on the magnet housing 20, the armature disk 40 and/or the hub flange 50 in a material-locking manner, in particular glued or molded on. The at least one first damping element 60 and/or the at least one second damping element 70 can also be arranged in a force- and/or form-locked manner.

The first damping element 60 and/or the second damping element 70 can preferably be made of a nonwoven or of an inorganic or organic friction lining such as LIQFRIC KV 251. The first damping element 60 and/or the second damping element 70 can also be made of a viscoelastic plastic, such as a polyurethane, e.g. a Sylomer®. The nonwoven can be made from felt wool M-3FAA, for example. The nonwoven can, for example, be designed as an untreated, impregnated and/or resin-impregnated nonwoven.

In FIGS. 2 and 3, the first damping element 60 and the second damping element 70 are manufactured as an inorganic or organic friction lining, which is applied to the respective component in a liquid phase and hardens there. The first damping element 60 and the second damping element 70 can just as well be made of a

For example, the viscoelastic plastic can have a static application range with a shape factor q=3 of between approx. 0.011 N/mm² and approx. 1.2 N/mm² and/or a static modulus of elasticity of approx. 0.06 N/mm² to approx. 15.62 N/mm² . For example, the viscoelastic plastic can be a Sylomer® SR 220, which has a static application range with a form factor q=3 of approx. 0.22 N/mm² and a static modulus of elasticity of approx. 1.47 N/mm² .

The second embodiment example as shown in FIGS. 4 and 5 differs from the first embodiment example in the selection of the material and the design of the at least one first damping element 60 and the at least one second damping element 70. The first damping element 60 and/or the second damping element 70 can be made of a Sylomer®, i.e. a PUR elastomer.

In particular, it can be seen from FIG. 5 that a plurality of first damping elements 60 are arranged around the longitudinal axis I over the circumference, with the respective first damping element 60 being arranged in a recess 28 in the magnet housing 20. The recess 28 is preferably adapted to the shape and size of the respective first damping element 60.

On the side of the armature disk facing the hub flange, a plurality of second damping elements 70 are arranged around the circumference, with the respective second damping element 70 being arranged in a recess 47 in the armature disk 40. The recess 47 is preferably adapted to the shape and size of the respective second damping element 70.

FIG. 6 shows a third embodiment example, wherein the at least one first damping element 60 can be arranged on the magnet housing 20, for example analogous to FIGS. 2 and 3 or 4 and 5.

In contrast to the previously described embodiment examples, the at least one second damping element 70 is now not arranged on the armature disk 40, but on the hub flange 50. More precisely, the at least one second damping element 70 is arranged at a free end of the adjusting means 54, by means of which a distance between the hub flange 50 and the armature disk 40 can be adjusted.

The at least one adjusting means 54 may comprise, for example, a spacer, a grub screw, a pin, a bolt or—as shown—a screw. The distance between the hub flange 50 and the armature disk 40 can be adjusted by the at least one adjusting means 54 and thus—preferably indirectly—also a distance between the armature disk 40 and the electromagnet 10.

A final exemplary embodiment example can be seen in FIGS. 7-9.

In this embodiment example, the at least one first damping element 60 and the at least one second damping element 70 are fixedly arranged on the armature disk 40. The at least one first damping element 60 is arranged on the side of the armature disk 40 facing the electromagnet 10 and the at least one second damping element 70 is arranged on the side facing the hub flange 50.

It can be seen from FIG. 9 that a plurality of first damping elements 60 are arranged around the longitudinal axis L on the side facing the electromagnet 10—i.e. the first contact side 41—of the armature disk 40. The first damping elements 60 are each recessed in a recess 46.

FIG. 8 shows the side of the armature disk 40 facing the hub flange 50 or the second contact side 42. The second damping element 70 can be in one piece and can be inserted approximately annularly around the longitudinal axis L, preferably in a recess 47.

Alternatively, analogous to the first damping elements 60 on the first contact side 41 facing the electromagnet 10, a plurality of second damping elements 70 can also be arranged on the second contact side 42 facing the hub flange 50, which are preferably each arranged in a recess 47.

According to FIG. 7, the armature disk 40 has a plurality of perforations 44 around the longitudinal axis L. The respective perforation 44 can be formed as a protrusion and can furthermore open out on the first contact side 41 in the recess 46 and/or on the second contact side 42 in the one recess 47 or the respective recess 46.

It is particularly preferred if the first damping element 60 or the first damping elements 60 and the one second damping element 70 are a one-piece damping element and engage around the armature disk 40 (not shown) and/or, as can be seen from FIG. 7 for example, engage through the armature disk 40.

The one-piece damping element can be easily attached by injection molding, for example.

### LIST OF REFERENCE SIGNS

1 brake or clutch
10 electromagnet
12 excitation coil
13 coil carrier
14 inner pole
16 outer pole
20 magnetic housing
21 inner ring section
22 base section
23 outer ring section
24 flange section
25 annular space
26 projection
27 projection
28 recess
30 permanent magnet
40 armature disk
41 first contact side
42 second contact side
44 perforation
45 resetting means
46 recess
47 recess
50 hub flange
52 fastening means
54 actuator
55 stop
56 stop surface
60 first damping element
70 second damping element
A, A′ distance
B distance
D, D′ thickness

1. An electromagnetic brake (1) or clutch, having
an electromagnet (10) arranged annularly around a longitudinal axis (L) with a magnet housing (20) having an inner pole (14) and an outer pole (16), an armature disk (40), and
a hub flange (50),
wherein the armature disk (40) is arranged between the hub flange and the electromagnet so as to be movable along the longitudinal axis (L) and can interact with the inner pole (14) and/or the outer pole (16) in a frictionally engaged manner,
characterized in that
at least one first elastic damping element (60) is provided between the electromagnet (10) and the armature disk (40) and/or at least one second elastic damping element (70) is provided between the armature disk (40) and the hub flange (50) for braking a movement of the armature disk (40).

2. The electromagnetic brake (1) or clutch according to claim 1,
characterized in that
the at least one first damping element and/or the at least one second damping element is elastically deformed in the longitudinal axis (L) by a displacement during deceleration of the armature, the displacement preferably being subject to the following: 0.02 mm≤displacement≤0.5 mm.

3. The electromagnetic brake (1) or clutch according to claim 1,
characterized in that
the at least one first damping element (60) is arranged such that the armature disk (40) is braked by an elastic deformation of the at least one first elastic damping element (60) before the armature disk (40) can interact with the inner pole (14) and/or with the outer pole (16) in a frictionally engaged manner.

4. The electromagnetic brake (1) or clutch according to claim 1,
characterized in that
the inner pole (14) and/or the outer pole (16) are formed by a projection (26, 27) projecting from the magnet housing (20).

5. The electromagnetic brake (1) or clutch according to claim 1,
characterized in that
the magnet housing (20) comprises a flange section (24), and in that the inner pole (14) is formed on the flange section (24) on the armature side.

6. The electromagnetic brake (1) or clutch according to claim 1,
characterized in that
the electromagnetic brake (1) or clutch is a permanent magnet brake or clutch and comprises a permanent magnet (30).

7. The electromagnetic brake (1) or clutch according to claim 1,
characterized in that
the at least one first damping element (60) is arranged adjacent to the inner pole (14) and/or to the outer pole (16) on the armature side of the magnet housing (20).

8. The electromagnetic brake (1) or clutch according to claim 1,
characterized in that
the at least one first damping element (60) protrudes beyond the inner pole (14) and/or the outer pole (16).

9. The electromagnetic brake (1) or clutch according to claim 1,
characterized in that
the at least one second damping element (70) is arranged such that the armature disk (40) comes into contact with the hub flange (50) in a damped manner by an elastic deformation of the at least one second damping element (70).

10. The electromagnetic brake (1) or clutch according to claim 1,
characterized in that
at least one adjusting means (54) is provided, and in that by means of the at least one adjusting means (54) a distance between the armature disk (40) and the inner pole (14) and/or outer pole (16) can be adjusted.

11. The electromagnetic brake (1) or clutch according to claim 1,
characterized in that
the at least one adjusting means (54) has the at least one second damping element (70).

12. The electromagnetic brake (1) or clutch according to claim 1,
characterized in that
the armature disk (40) comprises the at least one first damping element (60) and/or the at least one second damping element (70).

13. The electromagnetic brake (1) or clutch according to claim 1,
characterized in that
the at least one first damping element (60) and the at least one second damping element (70) are one piece.

14. The electromagnetic brake (1) or clutch according to claim 1,
characterized in that
the armature disk (40) is pulled against the hub flange (50) by resetting means (45).

15. The electromagnetic brake (1) or clutch according to claim 1,
characterized in that
the at least one first damping element (60) and/or the at least one second damping element (70) is a friction lining, a nonwoven or a viscoelastic plastic, in particular a Sylomer®.

16. The electromagnetic brake (1) or clutch according to claim 1,
characterized in that
the at least one first damping element (60) and/or the at least one second damping element (70) is glued or molded on.

17. The electromagnetic brake (1) or clutch according to claim 1,
characterized in that
a plurality of first damping elements (60) and/or second damping elements (70) is arranged around the longitudinal axis (L).

18. The electromagnetic brake (1) or clutch according to claim 1,
characterized in that
the at least one first damping element (60) and/or the at least one second damping element (70) is/are arranged or inserted in a recess.
